(19) United States
(12) Patent Application Publication
(10) Pub. No.: US 2024/0216903 A1
(43) Pub. Date: Jul. 4, 2024

(54) PROCESS FOR IN-SITU REGENERATION OF SPENT ION EXCHANGE RESIN CATALYST

(71) Applicant: Indian Oil Corporation Limited, Mumbai (IN)

(72) Inventors: Prosenjit MAJI, Faridabad (IN); Saravanan SUBRAMANI, Faridabad (IN); Satyen Kumar DAS, Faridabad (IN); Madhusudan SAU, Faridabad (IN)

(21) Appl. No.: 18/524,086

(22) Filed: Nov. 30, 2023

(30) Foreign Application Priority Data
Jan. 3, 2023 (IN) 202221062896

(51) Int. Cl. B01J 38/60; B01J 38/02; B01J 49/50

(52) U.S. Cl. CPC B01J 38/60; B01J 38/02; B01J 49/50

(57) ABSTRACT

The present invention relates to a process for in-situ regeneration of spent ion exchange resin catalyst used in the dimerization of olefins, etherification and alkylation processes by various impurities coming from feed streams and heavier oligomers forms as byproducts. The process involves backwashing with water which is followed by the step of naphtha washing. Naphtha washing involves filling the reactor with paraffinic naphtha and soaking the catalyst bed in naphtha. The step of naphtha washing is followed by naphtha circulation in the reactor. The last step involves treatment with diluted HCl solution wherein deposited impurities at the ion exchange sites are removed using diluted HCl. The process achieves up to 80% regeneration of spent catalysts.

### FIELD OF THE INVENTION

The present invention relates to a process for in-situ regeneration of spent ion exchange resin catalyst. More particularly, the present invention provides a process for the in-situ regeneration of spent ion exchange resin catalyst used in dimerization, etherification, and alkylation processes.

### BACKGROUND OF THE INVENTION

Ion exchange resin catalysts are commonly used for dimerization, alkylation, etherification, etc., processes employing refinery hydrocarbon feed having various impurities such as acetonitrile, propionitrile, amines or other basic nitrogen; different sulfur compounds such as mercaptans, sulfides, disulfides and dialkyl sulfides; dienes; metals in form of organometallic components or minerals. Ion exchange resin catalysts that are deactivated by ion exchange which is the reversible interchange of ions between a solid (ion exchange material) and a liquid, there is no permanent change in the structure of the solid. In this case the catalysts are easily regenerated by a regenerant solution (Acidic/Basic) in co-current or counter current flow. However, in the catalytic processes which involve hydrocarbon processing such as alkylation, etherification, dimerization etc., the reason for catalyst deactivation is due to deposition of several impurities from feed processed such as basic nitrogen, different sulfur species, metals etc. and due to uncontrolled oligomerization reaction over the catalyst surface. The present invention relates to a process for regeneration of ion exchange resin catalyst used in dimerization of olefins, alkylation and etherification which are deactivated by deposition of various impurities coming from feed streams and heavier oligomers forms as byproducts.

Various literature describes the regeneration of spent ion exchange resin catalyst using various methods, which include solvent extraction and acid-alkali treatments, washing the used catalyst with a low molecular weight Siloxane medium, using ammonia or amine solution, etc. Several methods for regeneration of ion exchange resin have been known in the art.

Malshe et. al. (1997) worked on the regeneration and reuse of cation-exchange resin catalyst used in alkylation of phenol. This process is to regenerate the catalysts, Indion-130 and Amberlyst-15, used in the alkylation reaction of phenol. The physically adsorbed impurities are removed by solvent extraction and acid-alkali treatments. Oxidation of the grafted phenolic compounds was performed by treatment with ozone and chlorine dioxide solutions. The treated resin was then subjected to sulfonation with chlorosulfonic acid in presence of ethylene dichloride solvent.

Publication number U.S. Pat. No. 6,809,053B2 discloses a method for reactivating sulfonated resin catalyst for use in the polymerization of Silicone oil. It was disclosed that a sulfonated resin catalyst which has been used in the polymerization of Silicone oil whereby the activity has been lowered can be reactivated by washing the used catalyst with a low molecular weight Siloxane medium, volatilizing off the Siloxane medium under atmospheric or reduced pressure, and removing water from the catalyst. With this method, the catalyst is effectively reactivated so that the service life thereof is prolonged.

Publication number U.S. Pat. No. 3,392,111 discloses a process where a macroporous sulfonic acid ion exchange resins containing an ion of a metal at its functional site used for sweetening of hydrocarbons (removal of mercaptans) are regenerated using ammonia or amine solution. The catalyst is a particulate ion exchange composition containing copper, mercury, silver, gold, platinum, or palladium. The ammonia solution appears to perform the dual function of removing organic foulants and reactivating the catalyst's active sights.

Publication number WO2015029057A2 discloses a process for regeneration of ion exchange resins that also involves a step for treatment of catalyst with naphtha.

Publication number US20020014459A1 discloses repeating at least twice a step comprising passing an aqueous solution of regenerant through the regeneration tower downward from a top part of the regeneration tower and thereafter passing ultra-pure water through the regeneration tower upward from a bottom of the regeneration tower.

Traditional processes employed in regenerating spent catalyst fail to provide solutions to the below given problems. In the petroleum refining and petrochemical industry lot of olefinic C4 and C5 streams are generated which contains reactive olefins such as isobutene, butane−1 and isoamylene. These olefins are conveniently upgraded to gasoline pool through dimerization, etherification and alkylation processes depending upon the refinery configuration and the product need. Most of these upgradation processes employ cationic ion exchange resin catalyst system. However, the feed streams contain various impurities at higher concentration as these streams are coming from secondary conversion units like FCCU, DCU which processes heavier residual streams having higher impurities. The impurities such as acetonitrile, propionitrile, amines or other basic nitrogen, different sulfur compounds such as mercaptans, sulfides, disulfides, dialkyl sulfides, dienes, metals in form of organometallic components or minerals deactivates the resin catalyst. Moreover, during the processing of the olefins particularly in the case of dimerization, heavier oligomers form due to uncontrolled side reactions which deposits on the catalyst pores and deactivates the catalyst.

Normally, the regeneration of the ion exchange catalyst is done by the acid treatment at moderate concentration which further requires costly metallurgy of the equipment resulting higher Capex. Hence, in some cases, the deactivated resins are replaced by the fresh catalyst instead of regeneration and reuse. The spent catalysts are used for land filling application. Moreover, no commercial technologies or processes offer to remove heavier oligomers from the catalyst and regenerate to significant level so that it can be reused. In this invention, a simple process is described for in-situ regeneration and reactivation of the spent ion exchange resins used in the dimerization, alkylation, or etherification processes. The process requires no specialized equipment, and the life of the catalyst can be doubled without compromising yield of product. Hence, the process can be applied to any of the existing units employing cation exchange resin catalyst and increase the catalyst life. The increased catalyst life and regaining of activity will increase the profit margin of the refinery as the fresh catalyst replacement period is minimized and the product yield improved due to catalyst regeneration. All these issues create problem in effective regeneration of spent catalyst. The process of the present invention overcomes the aforementioned drawbacks.

### SUMMARY OF THE INVENTION

The present invention describes a process for in-situ regeneration of spent catalyst, the process comprising; a) backwashing the catalyst with water; b) washing with naphtha; c) circulating the reactor with naphtha; d) regenerating the catalyst with the last step of treating the catalyst with dilute HCl.

### TECHNICAL ADVANTAGES OF THE INVENTION

The advantages of the present invention for regeneration of spent catalyst are:
The invention provides a process for regeneration of ion exchange resin catalyst used in the dimerization, etherification and alkylation processes which could not be easily regenerated by using simple diluted acidic solution as the deactivation in these processes occurs through multiple reasons and each poison affects the catalyst in different manner.
The process removes the deposited impurities and heavier oligomers that blocked the pores of the spent ion exchange resin catalysts.
The present invention increases the life of the ion exchange resin catalyst.
The present invention does not use the specialized metallurgy for regeneration of the spent ion exchange resin catalyst.
The process of present invention uses exceptionally low concentration of acid solution (0.1-0.5N HCl) for removing impurities from the catalyst and rejuvenating the catalyst activity.
The process of present invention can be applied to any of the existing units employing cationic ion exchange resin catalyst without any additional equipment.
The process can remove up to 90% of the nitrogenous and metallic impurities from the catalyst.
The process can remove up to 50% of the deposited heavier oligomers from the catalyst in a single treatment.
The process of present invention recovers up to 80% of the total exchange capacity of the spent cationic ion exchange catalyst.

### OBJECTIVE OF THE INVENTION

The primary objective of the present invention is to provide a process for regenerating ion exchange-based resin catalysts that are deactivated by deposition of nitrogenous and metallic impurities coming from feed stream and heavier oligomers which are a byproduct of the main application and significantly increasing the life of the ion exchange resin catalyst by regenerating the catalyst periodically by the methodology described in the present invention.

### BRIEF DESCRIPTION OF THE DRAWINGS

FIG. 1 relates to process of backwashing of the reactor with water.

FIGS. 1 and 2 relates to washing of the reactor with paraffinic naphtha.

FIG. 3 relates to naphtha circulation when effluent heater is used.

FIGS. 4 and 5 relate to naphtha circulation when reboiler is used.

### DETAILED DESCRIPTION OF THE INVENTION

Those skilled in the art will be aware that the present disclosure is subject to variations and modifications other than those specifically described. It is to be understood that the present disclosure includes all such variations and modifications. The disclosure also includes all such steps of the process, features of the system, referred to or indicated in this specification, individually or collectively and all combinations of any or more of such steps or features.

### Definitions

For convenience, before further description of the present disclosure, certain terms employed in the specification, and examples are collected here. These definitions should be read in the light of the remainder of the disclosure and understood as by a person of skill in the art. The terms used herein have their meanings recognized and known to those of skill in the art, however, for convenience and completeness, particular terms and their meanings are set forth below.

The articles “a,” “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only.”

Throughout this specification, unless the context requires otherwise the word “comprise,” and variations such as “comprises” and “comprising”, will be understood to imply the inclusion of a stated element or step or group of element or steps but not the exclusion of any other element or step or group of element or steps.

The term “including” is used to mean “including but not limited to.” “Including” and “including but not limited to” are used interchangeably.

Unless defined otherwise, all technical and scientific terms used herein have the same meaning as commonly understood by one of ordinary skill in the art to which this disclosure belongs. Although any methods and materials similar or equivalent to those described herein can be used in the practice or testing of the disclosure, the preferred methods, and materials are now described. All publications mentioned herein are incorporated herein by reference.

The present disclosure is not to be limited in scope by the specific embodiments described herein, which are intended for the purposes of exemplification only. Functionally equivalent products and processes are clearly within the scope of the disclosure, as described herein.

In the present invention, a spent ion exchange resin catalyst used in olefin dimerization, alkylation and etherification has been regenerated in-situ for reuse. According to the main embodiment of the present invention, the heavier oligomers deposited over the catalyst are removed by treatment with De-Mineralized (DM) water and paraffnic naphtha. The catalyst present in the reactor at its end of life is regenerated in-situ by adopting the methodology described in the process of present invention. The reactor must depressurize and flushed for remaining entrapped hydrocarbons. Catalyst is then regenerated in the same reactor.

In one embodiment of the present invention, the catalyst bed is soaked with DM water or boiler feed water (BFW) or steam condensate water for 3-4 hours. The temperature of the water used is kept between 80-90° C. and pressure is kept between 2-6 bar. The remaining water from the reactor is drained after soaking. The soaking is done twice.

In other embodiment of the present invention, the water-soaked catalyst bed is backwashed with DM water or BFW or steam condensate till the color of the effluent water clears or up to 5 hours whichever is earlier. The backwashing is conducted by flowing the water from the bottom of the reactor. The backwashing is conducted at atmospheric pressure and the temperature of the water is maintained between 80-90° C. After completion of backwashing, the remaining water from the reactor is drained and the water washed catalyst bed is allowed to settle for 1-2 hours.

In another embodiment of the present invention, the water washed catalyst bed is soaked with paraffinic naphtha boiling in the range of C5-90° C. for 48 hours. The temperature of the naphtha is kept between 60-80° C., and the reactor pressure is maintained between 5-10 bar. During soaking of naphtha, absorbed water from catalyst pores are released and settled at the bottom of the reactor which is discarded every 4 hours and the same volume of naphtha is charged in the reactor. The batch of naphtha from the reactor after 48 hours is discarded and refilled the reactor with fresh naphtha. The same is repeated twice.

In other embodiment of the present invention, the water and naphtha-soaked catalyst bed is further treated with circulated paraffinic naphtha boiling in the range of C5-90° C. for 24-36 hours. The temperature of the naphtha is kept between 60-80° C., and the reactor pressure is maintained between 5-10 bar during the circulation of naphtha. The naphtha is circulated through an effluent heater to maintain the temperature of the naphtha and a stream of 20-50% of the effluent steam is continuously discarded from the system and make up stream of fresh naphtha is charged.

In further embodiment of the present invention, the activity of the catalyst is rejuvenated using diluted hydrochloric acid (HCl) solution of normality ranging between 0.1-0.5 N. The deposited impurities at the ion exchange sites are removed using diluted HCl solution. In a preferred embodiment, this has been done after completion of water and naphtha treatment.

The diluted acid solution is passed through the catalyst bed from the top or bottom of the catalyst bed. The acid treatment is conducted at normal temperature and pressure. The flow rate for diluted acid solution is maintained at 1 liter per liter of catalyst per hour and the same is maintained for 4-8 hours depending upon the concentration of HCl solution and the number of impurities deposited on the catalyst. After completion of the acid treatment the catalyst bed is rinsed with DM water for 30 minutes.

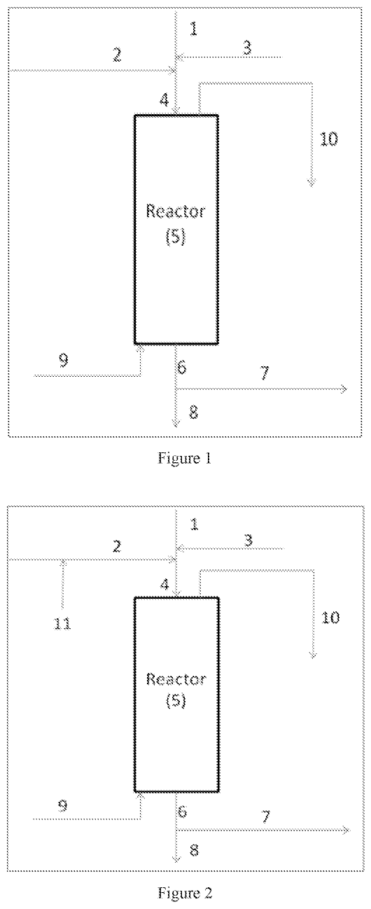

As per the schemes represented by FIGS. 1 to 5, the catalyst present in the reactor is regenerated in four stages as described below:

Stage-1 (Backwashing with water); The reactor is first filled with DM water through the process fluid intake line (2) and soaked the bed in DM water for 3-4 hours, the temperature of the DM Water used is kept between 80-90° C. and pressure is kept between 2-6 bar. The same is practiced twice and then the water is drained from the reactor. The DM Water may be replaced by condensate water or boiler feed water (BFW) based on the availability. In the next step, backwashing conducted in closed loop whereby the hot DM water (80-90° C.) is passed through the bottom line (9) and the effluent water is drained from the top (10) till the color of the DM water clears or up to 5 hours whichever is earlier.

Stage-2 (Naphtha wash); After completion of backwash with hot water, water is drained from the reactor (8) and filled with paraffinic naphtha boiling in the range of C5-90° C. (3), kept for 48 hours at the naphtha filled condition to diffuse the impurities from catalyst pores to naphtha layer and to settle the water from the catalyst bed to the reactor bottom. The temperature of the naphtha is kept between 60-80° C., and the reactor is maintained between 5-10 bar. Remaining water from the catalyst pores as settled at the bottom of the reactor are drained in every 4 hours and same volume is filled with naphtha. The batch of naphtha from the reactor after 48 hours is discarded and refilled the reactor with fresh naphtha. The same is repeated twice.

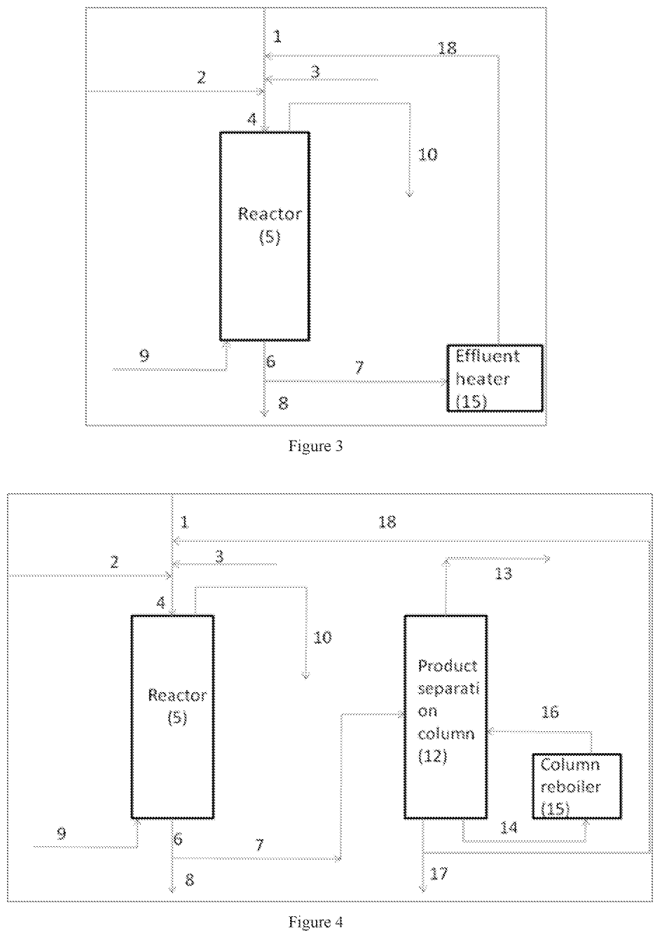

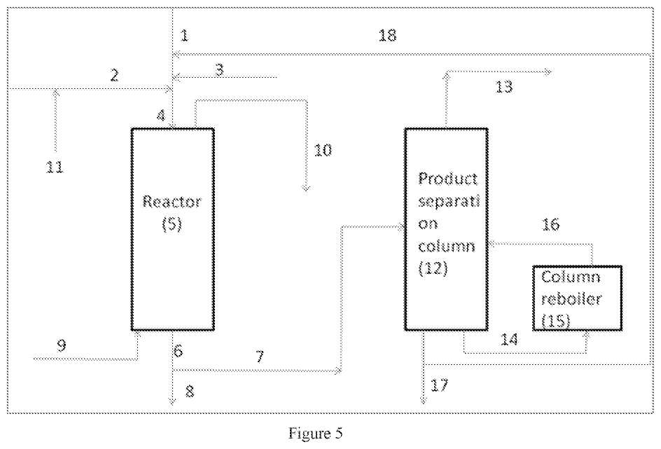

Stage-3 (Naphtha circulation); The first batch of naphtha from the reactor after soaking is discarded and refilled the reactor with fresh naphtha and started the circulation of naphtha through an effluent heater (15) to incorporate the heat losses during the circulation (Scheme in FIG. 3). The effluent heater can be replaced by the reboiler (15) of product separation column (12), if available. In this case, the effluent stream is sent to the column through column feed inlet (7) and drawn from the column bottom and recirculated back to the reactor (18) (FIG. 4 and FIG. 5). A stream of 20-50% of the effluent steam is continuously discarded through reactor bottom (8) throughout the circulation of naphtha and the same is incorporated by adding make up fresh naphtha. The circulation of naphtha is continued for 24 hours (FIG. 3 to FIG. 5)

In further embodiment of the present invention, the catalyst is regenerated using diluted HCl solution (FIG. 2 and FIG. 5). The deposited impurities at the ion exchange sites are removed using diluted HCl solution of normality 0.1-0.5 N. In a preferred embodiment, this has been done after completion of DM water and naphtha treatment. After draining naphtha from the reactor, DM Water is started from the top of the reactor (2) and HCl is dosed in the DM water (11). The flow rate for diluted acid solution is maintained at 1 liter per liter of catalyst per hour. The flow is maintained for 4-8 hours depending upon the concentration of HCl solution used. After completion of the acid treatment the catalyst bed is rinsed with DM water for 30 minutes.

The present invention discloses a process for in-situ regeneration of spent catalyst, the process comprising:
a) hot water to a reactor through an intake line (2) for soaking the spent catalyst bed for a period of 3-4 hours;
b) repeating step a) twice and draining the hot water through a line (8);
c) feeding the hot water through a bottom line (9) and draining effluent water from a top line (10) till colour of the effluent water is clear or for a period of up to 5 hours;
d) filling the reactor with paraffinic naphtha through a line (3) and keeping for 48 hours to diffuse the impurities from catalyst pores to naphtha layer and settle water along with impurities from the spent catalyst bed to the reactor bottom;
e) draining the settled water from the reactor every 4 hours and filling the reactor with fresh naphtha;
f) feeding an effluent stream through a feed inlet (7), drawing from bottom, and recirculating back to the reactor a period of 24 hours; and
g) removing deposited impurities on the spent catalyst using diluted HCl treatment.

### EXAMPLES

Having described the basic aspects of the present invention, the following non-limiting examples illustrate specific embodiments thereof. Those skilled in the art will appreciate that many modifications may be made in the invention without changing the essence of invention.

### Example—1

This example shows the composition of spent catalyst received from a dimerization unit. Nitrogen and iron are deposited over the catalyst along with the increase in the hydrocarbon content.

TABLE 1
Composition of fresh and spent catalyst

| | Total | | | | | |
|---|---|---|---|---|---|---|
| | exchange | | | | | |
| Catalyst | capacity | Carbon | Hydrogen | Nitrogen | Sulfur | Metals |
| descriptions | meq/gm | % | % | % | % | PPMW |
| Fresh catalyst | 5.3 | 36 | 4.7 | <0.1 | 16.1 | Al: 25, |
| | | | | | | Ca: 16, |
| | | | | | | Fe: 21, |
| | | | | | | Mg: 10, |
| | | | | | | Na: 12 |
| Spent | 2.8 | 56.1 | 6.8 | 1.1 | 10.7 | Al: 32, |
| catalyst from | | | | | | Ca: 19, |
| reactor 1 | | | | | | Fe: 129, |
| | | | | | | Mg: 11, |
| | | | | | | Na: 14 |
| Spent | 2.9 | 58.2 | 7.0 | 3.1 | 10.4 | Al: 53, |
| catalyst from | | | | | | Ca: 32. |
| reactor-2 | | | | | | Fe: 2945, |
| | | | | | | Mg: 15, |
| | | | | | | Mn: 43, |
| | | | | | | Na: 31 |

From the above table, the catalyst acid capacity is decreased from 5.3 to 2.8 and 2.9 meq/gm for spent catalyst from reactor-1 and reactor-2, respectively. This may be attributed to the presence of nitrogenous compounds in both the spent catalysts which is observed from the CHNS (Carbon, Hydrogen, Nitrogen and Sulfur) analysis of catalyst. It is to be noted that there is no nitrogen present in fresh catalyst. Also, from CHNS analysis, it is seen that there is an increase in hydrocarbon content on the spent catalyst, which is due to formation of heavier oligomers inside the catalyst which in turn may lead to reduction in activity of the catalyst. The metal analysis clearly indicates that there is significant increase in iron (Fe) content in both the spent catalyst, which may also lead to deactivation of the catalyst. The loss of sulfur in spent catalyst as compared to fresh catalyst is found to be insignificant after normalizing with respect to increased hydrocarbon and nitrogen content of the spent catalyst.

### Example—2

This example shows the effect of different impurities on ion exchange resin catalyst. Different impurities containing nitrogen, sulfur and iron are doped on the fresh catalyst. For doping the impurities on the fresh catalyst, different impurities such as ethanolamine, methyldiethanolanine (MDEA), ferrous sulfate and dimethyl sulfide (DMS) are dissolved in De-Mineralized water in a quantity of mol equivalent of targeted impurity doping level. The quantity of DM water is taken as 10 ml/ml of fresh catalyst. The fresh catalyst is then soaked in the solution of impurities for overnight. After completion of soaking, effluent solution is discarded, and the catalyst is rinsed with DM water by flowing 20 ml/min per milliliter of catalyst. The doped catalyst is then calcined for 4 hours at 120° C. The calcined catalyst is then characterized for elemental analysis (carbon, hydrogen nitrogen, sulfur, and iron). The total exchange capacity of the impurity doped catalyst is also measured by soaking one gram of catalyst in 0.5N NaOH solution for 16 hours and then titrating with 0.1N HCl solution. The effect of different impurities on the total exchange capacity is given in Table 2. Drastic change in total exchange capacity is observed for doping with ethanolamine and almost no change is observed for doping with DMS.

TABLE 2
Effect of impurities

| | Total | | | | | |
|---|---|---|---|---|---|---|
| Catalyst | exchange | | Hydro- | Nitro- | | |
| de- | capacity | Carbon | gen | gen | Sulfur | Iron |
| scriptions | meq/gm | Wt % | Wt % | Wt % | Wt % | PPMW |
| Fresh | 5.3 | 36 | 4.7 | <0.1 | 16.1 | 0 |
| catalyst | | | | | | |
| Ethanol- | 0.44 | 41.2 | 5.5 | 4.7 | 14.9 | 0 |
| amine | | | | | | |
| doped | | | | | | |
| catalyst | | | | | | |
| MDEA | 1.92 | 38.0 | 5.2 | 2.8 | 15.0 | 0 |
| doped | | | | | | |
| catalyst | | | | | | |
| Iron | 3.08 | 38.5 | 4.8 | <0.1 | 17.1 | 4065 |
| doped | | | | | | |
| catalyst | | | | | | |
| DMS | 5.19 | 36.4 | 4.9 | <0.1 | 17.0 | 0 |
| doped | | | | | | |
| catalyst | | | | | | |

### Example—3

This example shows the effect of washing of spent catalyst with DM Water and Naphtha. The spent catalyst is washed with DM water or naphtha or both by flowing the solvent from top of a catalyst bed at the rate of 5 ml/min/ml of catalyst for 1 hour. This has been conducted at room temperature and atmospheric pressure. The catalyst is characterized for elemental analysis and total exchange capacity after calcining at 120′° C. for 4 hours. This example shows that the simple washing or backwashing at room temperature of the spent catalyst does not have any impact on removing heavier oligomers from the spent catalyst as the CHNS composition of the treated catalyst remains unchanged.

TABLE 3
Effect of catalyst washing with DM Water and naphtha

| | | Total | | | | |
|---|---|---|---|---|---|---|
| | | exchange | | | | |
| S. | Catalyst | capacity | Carbon | Hydrogen | Nitrogen | Sulfur |
| No. | descriptions | meq/gm | Wt % | Wt % | Wt % | Wt % |
| 1 | Spent catalyst | 2.90 | 58.2 | 7.0 | 3.1 | 10.4 |
| | without any | | | | | |
| | treatment | | | | | |
| 2 | Spent catalyst after | 3.19 | 55.3 | 7.0 | 3.5 | 11.2 |
| | washing with DM | | | | | |
| | Water | | | | | |
| 3 | Spent catalyst after | 2.77 | 55.6 | 7.0 | 3.5 | 11.1 |
| | washing with | | | | | |
| | naphtha | | | | | |
| 4 | Spent catalyst after | 3.02 | 55.0 | 6.9 | 3.6 | 11.2 |
| | washing with water | | | | | |
| | followed by Naphtha | | | | | |

### Example—4

This example shows the effect of spent catalyst treatment using different regenerant solution. It is observed that, the catalysts which are deactivated mainly because of deposition of different nitrogenous and metallic impurities can be regenerated completely by treatment with diluted acid solution. It is further observed that in some cases where the regeneration has been done using sulfuric acid solution, the regenerated spent catalyst is having total exchange capacity is more than that of the fresh catalyst. This is due to resulfonation of the sulfonic acid sites of spent catalyst. It is also observed that the regeneration of the spent catalyst by removal of impurities can also be possible by much diluted solution of HCl (0.1 N). This is advantageous in view of the material of construction (MOC) of existing reactors. However, acid regeneration is not much effective for the actual spent catalysts which are deactivated due to the deposition of heavier oligomers.

TABLE 4
Regeneration of spent catalyst with different regenerant solution

| | Total exchange capacity, meq/gm | | | | | | | |
|---|---|---|---|---|---|---|---|---|
| | | | Treated | | | | | |
| | | | with | | | | | |
| | | | 10% | | | | | |
| | | | brine | | | | | |
| | | | solution | Treated | | | | |
| | | | followed | with | Treated | Treated | Treated | Treated |
| | | Treated | by | 10% | with | with | with | with |
| | | with | 10% | (v/v) | 0.1N | 0.2N | 0.5N | 10% |
| | | 10% | (v/v) | HCl | HCl | HCl | HCl | (v/v) |
| Catalyst | Without | brine | HCl | solution | solution | solution | solution | H₂SO₄ |
| descriptions | treatment | solution | solution | only | only | only | only | solution |
| Spent | 3.24 | 3.26 | 3.29 | 3.49 | — | — | — | 3.90 |
| catalyst | | | | | | | | |
| Ethanolamine | 0.44 | 0.00 | 4.20 | 4.80 | 3.62 | 4.95 | 4.83 | 4.86 |
| doped | | | | | | | | |
| catalyst | | | | | | | | |
| MDEA | 1.92 | 0.23 | 4.82 | 4.71 | 3.77 | 5.03 | 5.07 | 5.38 |
| doped | | | | | | | | |
| catalyst | | | | | | | | |
| Iron doped | 3.08 | 0.00 | 3.91 | 5.20 | 4.36 | 5.07 | 4.95 | 5.62 |
| catalyst | | | | | | | | |

### Example—5

This example shows the effect of catalyst swelling by soaking in water. It is observed that, the catalyst bed swells up to 24% in 37-48 hours when kept at ambient temperature. However, with increasing temperature, swelling rate increases significantly. At 90° C., maximum catalyst swelling of 35% achieved within 12 hours while the same is increased to 39% maximum upon soaking for longer time. Further increase in temperature is not recommended due to lower thermal stability of the catalyst. Similar experiments are also performed where the spent catalyst is soaked in naphtha. However, no swelling is observed in case of soaking in naphtha.

TABLE 5
Swelling of catalyst bed

| | Swelling of catalyst, Vol % | | |
|---|---|---|---|
| | Temperature | | |
| | Temperature: | Temperature: | Temperature: |
| Soaking time | 35° C. | 60° C. | 90° C. |
| 12 hours | 3 | 20 | 35 |
| 24 hours | 7 | 28 | 39 |
| 36 hours | 23 | 31 | 39 |
| 48 hours | 24 | 31 | 39 |

The soaking time can further be reduced by slightly increasing the water pressure. However, there is no effect of pressure observed beyond 2 bar within the soaking time of 24 hours. At the atmospheric condition, the spent catalyst floats over the water as the catalyst surface become non-hygroscopic due to deposition of non-polar heavier oligomers. With increasing temperature and pressure faster wetting of the catalyst surface happens and hence swelling rate increases. Due to swelling of the catalyst, the pore mouths of the catalyst widen creating a passage for the trapped heavier hydrocarbons to come out.

TABLE 6
Effect of pressure on swelling of catalyst bed

| | Swelling of catalyst, Vol % | | | |
|---|---|---|---|---|
| | Pressure | | | |
| | | Pressure: | Pressure: | Pressure: |
| Soaking time | Atmospheric | 2 bar | 4 bar | 6 bar |
| 12 hours | 13 | 20 | 20 | 20 |
| 24 hours | 24 | 28 | 28 | 27 |

### Example—6

This example shows the effect of soaking with naphtha on the water swelled spent catalyst. The water-soaked catalyst with 35% of swelling has been further soaked in naphtha. Prior to naphtha soaking, free water from the catalyst is removed using a water draining apparatus. Table 7 shows change of water swelling conditions when further soaked in naphtha at different pressure. The temperature of the naphtha was kept at 90° C. while soaking. There is minor contraction of the catalyst bed observed when further soaked in naphtha at higher pressure due to settling of water from catalyst pores to the bottom of the bed.

TABLE 7
Change in water swelling conditions due to naphtha soaking

| | Swelling condition of catalyst, Vol % | | | |
|---|---|---|---|---|
| | Pressure | | | |
| | | Pressure: | Pressure: | Pressure: |
| Soaking time | Atmospheric | 2 bar | 4 bar | 6 bar |
| 12 hours | 35 | 34 | 31 | 29 |
| 24 hours | 35 | 32 | 28 | 25 |

### Example—7

This example shows the effect of methodical regeneration of spent catalyst using water, naphtha and diluted HCl solution. The fresh catalyst having total exchange capacity of 5.3 meq/gm has undergone olefin dimerization process. At the start of run (SOR) condition 24.1% of yield of product is obtained and as the catalyst deactivates the yield of product has been reduced to 9.1%. The total exchange capacity has been reduced to 2.9 meq/gm. The deactivation occurred due to deposition of heavier oligomers as observed from the increase in carbon and hydrogen content of the spent catalyst and due to deposition of nitrogenous and iron containing impurities. The regeneration of this spent catalyst has been done in a methodical way in three stages. Firstly, the catalyst bed is washed with pressurized hot DM water (Pressure; approximately 4 bar and Temperature: approximately 80° C.). For washing the catalyst bed with water, first the catalyst was soaked in water for 4 hours and drained the water.

The same is repeated twice. This is done to replace the catalyst pores by water and remove any entrapped free hydrocarbons. In the next step backwashing conducted for 5 hours. Catalyst fines were removed during backwashing. In this washing step, catalyst bed swells and pores are opens. In the next stage, catalyst bed is washed with hot pressurized naphtha (Temperature: approximately 70° C. and Pressure: approximately 6 bar). The catalyst bed is kept in naphtha soaking for 48 hours and then discarded the batch of naphtha. At this condition heavier oligomers diffused from swelled pores to the naphtha layer. This batch of naphtha is discarded and washed the catalyst bed further with fresh circulating naphtha for 48 hours. A stream from the circulating naphtha is continuously discarded (approximately 15-20%). After completion of naphtha wash catalyst bed is treated with 0.1 N diluted HCl solution at the rate of 2-5 ml/gm of catalyst/min for 1 hour.

It is observed that, the carbon and hydrogen content of the spent catalyst has been reduced significantly which implies the removal of deposited heavier oligomers from the catalyst. Along with this the deposited nitrogenous impurities are also removed by water and naphtha wash. Deposited irons are not removed completely which is further removed by treatment of diluted HCl solution.

TABLE 8
Regeneration of spent catalyst with different methodical circulation of DM Water and
Naphtha

| | | Total | | | | | | |
|---|---|---|---|---|---|---|---|---|
| | | exchange | | | | | | Product |
| S. | Catalyst | capacity | Carbon | Hydrogen | Nitrogen | Sulfur | Iron | yield |
| No. | descriptions | meq/gm | Wt % | Wt % | Wt % | Wt % | PPMW | % |
| 1 | Fresh | 5.3 | 36 | 4.7 | <0.1 | 16.1 | 0 | 24.1 |
| | catalyst at | | | | | | | |
| | SOR | | | | | | | |
| 2 | Spent | 2.9 | 58.2 | 7.0 | 3.1 | 10.4 | 2945 | 9.1 |
| | catalyst after | | | | | | | |
| | deactivation | | | | | | | |
| | at EOR | | | | | | | |
| 3 | Spent | 3.90 | 50.7 | 6.4 | <0.1 | 14.0 | 821 | 22.8 |
| | catalyst after | | | | | | | |
| | methodical | | | | | | | |
| | regeneration | | | | | | | |
| | with DM | | | | | | | |
| | Water and | | | | | | | |
| | Naphtha | | | | | | | |
| 4 | Spent | 4.1 | 49.6 | 6.3 | <0.1 | 14.1 | 300 | — |
| | catalyst after | | | | | | | |
| | methodical | | | | | | | |
| | treatment | | | | | | | |
| | with DM | | | | | | | |
| | Water and | | | | | | | |
| | naphtha | | | | | | | |
| | followed by | | | | | | | |
| | acid | | | | | | | |
| | treatment | | | | | | | |

### Example—8

This example shows the analysis of effluent streams after methodical treatment with DM Water and Naphtha of a catalyst bed which has been used in a process to dimerize isobutene prior to its deactivation. The deactivation has happened majorly by deposition of heavier oligomers such as timers and tetramers of isobutene formed as byproduct of isobutene dimerization. The effluent is separated in two layers viz., water and naphtha layers. The naphtha layer shows 300 kg/m³ of existent gum content in which it is further analyzed by Gel permeation chromatography (GPC) found that two polymeric compounds with Molecular weights of 3357 and 630 in weight fractions of 0.36 and 0.64 respectively are present in the naphtha rich effluent. On further analysis by mass spectroscopy, olefinic trimers and tetramers of C4H8 (isobutene) are identified. Hence, the deposited trimers, tetramers and further heavier oligomers which were deposited causing catalyst deactivation were removed during methodical treatment with DM Water and Naphtha after deactivation and the same is landed up in the washed effluent streams.

We claim:

1. A process for in-situ regeneration of spent catalyst, the process comprising:
a) feeding hot water to a reactor through an intake line (2) for soaking the spent catalyst bed for a period of 3-4 hours;
b) repeating step a) twice and draining the hot water through a line (8);
c) feeding the hot water through a bottom line (9) and draining effluent water from a top line (10) till colour of the effluent water is clear or for a period of up to 5 hours;
d) filling the reactor with paraffinic naphtha through a line (3) and keeping for 48 hours to settle water from the spent catalyst bed to the reactor bottom;
e) draining the settled water from the reactor every 4 hours and filling the reactor with fresh naphtha;
f) feeding an effluent stream through a feed inlet (7), drawing from bottom, and recirculating back to the reactor a period of 24 hours; and
g) removing deposited impurities on the spent catalyst using diluted HCl treatment.

2. The process as claimed in claim 1, wherein hot water comprises demineralized (DM) water or steam condensate or boiler feed water (BFW).

3. The process as claimed in claim 1, wherein in step a) temperature of the hot water ranges from 80-90° C. and pressure ranges from 2-6 bar.

4. The process as claimed in claim 1, wherein in step d) temperature of the paraffinic naphtha ranges from 60-80° C. and pressure ranges from 5-10 bar.

5. The process as claimed in claim 1, wherein in step d) batch of paraffinic naphtha from the reactor is discarded after 48 hours and the reactor is refilled with fresh naphtha.

6. The process as claimed in claim 1, wherein in step f) fresh naphtha is circulated through an effluent heater/reboiler (15).

7. The process as claimed in claim 1, wherein in step f) 20-50% of the effluent steam is continuously discarded through reactor bottom (8) throughout the circulation of naphtha and the same is incorporated by adding make up fresh naphtha.

8. The process as claimed in claim 1, wherein in step g) demineralized (DM) water dosed with the diluted HCl is fed from the top of the reactor (2).

9. The process as claimed in claim 1, wherein in step g) after completion of the diluted HCl treatment the spent catalyst bed is rinsed with demineralized (DM) water for 30 minutes.

10. The process as claimed in claim 1, wherein normality of the diluted HCl ranges from 0.1-0.5 N.

11. The process as claimed in claim 1, wherein the spent catalyst comprises spent ion exchange resin catalyst used in dimerization, etherification, and alkylation processes.

12. The process as claimed in claim 11, wherein the spent ion exchanges resin catalyst comprises deposition of nitrogenous and metallic impurities, and heavier oligomers.

13. The process as claimed in claim 1, wherein the process removes up to 90% of the nitrogenous and metallic impurities and up to 50% of the heavier oligomers.

14. The process as claimed in claim 1, wherein the process recovers up to 80% of total exchange capacity of the spent ion exchange resin catalyst.
